(19) United States
(12) Patent Application Publication
(10) Pub. No.: US 2023/0220209 A1
(43) Pub. Date: Jul. 13, 2023

(54) HIGH LENGTH/DIAMETER RATIO CELLULOSIC POLYMER ADMIXTURE ARTICLES AND METHODS TO MAKE THEM

(71) Applicant: Martin Studios LLC, Clarkston, MI (US)

(72) Inventors: Dustin Martin, Clarkston, MI (US); Brian Rose, Willowbrook, IL (US)

(21) Appl. No.: 18/152,915

(22) Filed: Jan. 11, 2023

Related U.S. Application Data
(60) Provisional application No. 63/298,339, filed on Jan. 11, 2022.

(51) Int. Cl. C08L 97/02; C08L 23/06; C08L 23/12

(52) U.S. Cl. CPC C08L 97/02; C08L 23/06; C08L 23/12

(57) ABSTRACT

A method of making an article comprising injecting an admixture of a cellulosic material and a thermoplastic polymer into a mold cavity with single point of injection, wherein the cellulosic material is present in quantities ranging from about 10 to about 70 percent by weight with respect to the total weight of the admixture, wherein the admixture has about a melt flow rate of about 1 to 30 g/10 min, (2.16 kg; 210° C.), and wherein the article has a length-to-diameter ratio of at least about 5:1.

### TECHNICAL FIELD

This disclosure relates to an admixture of a reinforcing agent and a cellulosic material capable of being formed into a high length-to-diameter ratio article. This disclosure also relates to a method of making such article.

### BACKGROUND

Historically, artisan's preference in choosing a paint brush has been a handle made of wood. Wood unfortunately has become increasingly expensive and frequently is in short supply. In order to make a wooden paint brush handle of the desired size and shape, wood is typically machined, resulting in significant waste. Moreover, the porosity of treated and untreated wooden paint brushes poses potential issues for an artisan when cleaning their brushes. When using latex paint, for example, artisans clean their brushes with water and often submerge the brush in the water. The wooden paint brush can become swollen with water when submerged for extended periods of time, causing possible rot or warping. Therefore, it is desirable to have a paint brush handle made of a composition that mimics the preferred features wood, such as the weight and feel, but is made with inexpensive and more readily available materials capable of long-lasting use.

Another concern of many artisans is reducing their environmental footprint. Reduction in environmental footprint typically entails reduction in environmental pollution where possible, reuse of materials that would otherwise go to landfills, and recycling. Artisans, therefore, seek to use art supplies that are greener or more eco-friendly than traditional supplies and use recycled or sustainable sources of manufacture. This includes reducing the consumption of petroleum-derived polymers.

Attempts have been made to manufacture paint brushes using injection molded polyethylene as a substitute for wood. While these polyethylene molded paint brushes are less expensive compared to wooden paint brushes, the polyethylene paint brushes are often extremely slick and difficult to grasp. Slickness occurs when the artisan inevitably drips paint upon the brush or perspires as he or she works. Meeting this issue, attempts have been made to make polyethylene brushes easier to grasp by using foamed polyurethane as is seen in U.S. Pat. No. 3,819,779 or co-injecting foamed polyolefin and elastomeric materials to create a layered paint brush handle as is seen in U.S. Pat. No. 5,800,751. While these attempts address the tactile experience of the paint brush handle, they do not address the environmental concerns of artisans.

It would be desirable to provide a handle or the like that avoids one or more of the problems of the prior art such as described above. In particular, it would be desirable to provide a paint brush handle that is comprised of a combination of recycled and sustainable materials that mimics the characteristics of wood, such as the feel and ability to absorb sweat, while avoiding, for example, wood machining waste and degradation.

### SUMMARY

It has been discovered that particular mixtures of cellulosic particulates and polyolefins may be formed into high length/diameter (L/D) ratio parts such as handles for paint brushes or rollers, where the handles have sufficient cellulosic material such that the surface mimics the feel of an unfinished wood paint brush (e.g. does not get slippery during use). Likewise, it has been discovered that particular mixtures of the cellulosic particulates and polyolefins allow for the economical molding by high throughput processes such as injection molding with the desired surface roughness and without knit lines.

In some aspects, the techniques described herein relate to an article including: a shaped article including an admixture of a cellulosic material and a thermoplastic polymer, wherein the cellulosic material is present in quantities ranging from about 10 to about 70 percent by weight with respect to the total weight of the admixture, wherein the admixture has about a melt flow rate of about 1 to 30 g/10 min, (2.16 kg; 210° C.), and wherein the shaped article has a length-to-diameter ratio of at least about 5:1.

In some aspects, the techniques described herein relate to an article, wherein the cellulosic material includes one or more of bamboo, wood, rice hulls, hemp, straw, and flax.

In some aspects, the techniques described herein relate to an article, wherein the cellulosic material is a fiber, powder, or mixtures thereof.

In some aspects, the techniques described herein relate to an article, wherein the length-to-diameter ratio of the cellulosic material is at least about 10:1.

In some aspects, the techniques described herein relate to an article, wherein the length of the cellulosic material is at least about 0.01 mm to about 5 mm.

In some aspects, the techniques described herein relate to an article, wherein the cellulosic material is bamboo fiber and the length of the bamboo fiber is at least about 0.1 mm.

In some aspects, the techniques described herein relate to an article, wherein the thermoplastic polymer includes an olefin.

In some aspects, the techniques described herein relate to an article, wherein the olefin includes 1-olefins containing 2-10 carbons.

In some aspects, the techniques described herein relate to an article, wherein the olefin includes polyethylene, polypropylene, and/or a copolymer.

In some aspects, the techniques described herein relate to an article, wherein the thermoplastic polymer is a post-consumer and/or post-industrial, recycled polymer.

In some aspects, the techniques described herein relate to an article, wherein the admixture further includes a compatibilizing agent.

In some aspects, the techniques described herein relate to an article, wherein the compatibilizing agent includes one or more of: a titanium alcoholate; phosphoric acid ester, phosphorous acid ester, phosphonic acid ester, and silicic acid ester; metallic salts and esters of aliphatic, aromatic or cycloaliphatic acids; ethylene-acrylic acid copolymer (EAA), ethylene-methacrylic acid copolymer (EMAA), ethylene-ester of acrylic acid, ethylene ester or methacrylic acid, ethylene-vinyl acetate (EVA), styrene-maleic anhydride copolymer (SMA) or esters, acrylonitrile-butadiene-styrene copolymer (ABS), methacrylate-butadiene-styrene copolymer (MBS), styrene-acrylonitrile copolymer (SAN), or butadiene-acrylonitrile copolymer; and maleic anhydride or ester, acrylic or methacrylic acid or ester, vinyl acetate, acrylonitrile, and styrene.

In some aspects, the techniques described herein relate to an article, wherein the admixture further includes a plasticizer.

In some aspects, the techniques described herein relate to an article, wherein the plasticizer includes one or more of: phosphates, glycerides and esters of higher fatty acids and amides, glycol esters of coconut oil fatty acids, acetylated monogylceride, glycerine, dibutyl phthalate, diphenyl phthalate, castor oil, dicylclohexyl phthalate, butyl phthalyl, butyl glycolate, butyl ricinoleate, cresyldiphenyl phosphate, butyl stearate, benzyl phthalate, triethylcitrate, dibutylsebacate, sorbitol and triacetin or mixture thereof. D-sorbitol, triethylcitrate or mixtures thereof.

In some aspects, the techniques described herein relate to an article, wherein the admixture further includes a stabilizer.

In some aspects, the techniques described herein relate to an article, wherein the stabilizer includes one or more of phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and and mixtures thereof.

In some aspects, the techniques described herein relate to an article, wherein the average surface roughness (Ra) of the shaped article is about 0.2 to about 25 micrometers.

In some aspects, the techniques described herein relate to an article, wherein the shaped article absorbs water at a rate of about 0.2 to about 10 kg/m2s1/2 (ISO 15148).

In some aspects, the techniques described herein relate to an article, wherein the shaped article is a paint tool.

In some aspects, the techniques described herein relate to an article, wherein the shaped article is a paint brush, a paint brush roller core, a paint roller handle, a tray pan, a stir stick, a scraper, a paint pail, a bucket, a cut-in pail, an extension pole, a wire brush handle, a deck brush, a snap knife, a bucket opener, a can spout, a funnel, a paint pad handle, a sander handle, a trough, or a trim guide.

In some aspects, the techniques described herein relate to a method of making an article including: injecting an admixture of a cellulosic material and a thermoplastic polymer into a mold cavity with single point of injection, wherein the cellulosic material is present in quantities ranging from about 10 to about 70 percent by weight with respect to the total weight of the admixture, wherein the admixture has about a melt flow rate of about 1 to 30 g/10 min, (2.16 kg; 210° C.), and wherein the article has a length-to-diameter ratio of at least about 5:1.

In some aspects, the techniques described herein relate to a method, wherein the cellulosic material includes one more of bamboo, wood, rice hulls, hemp, straw, and flax.

In some aspects, the techniques described herein relate to a method, wherein the cellulosic material is a fiber, powder, or mixtures thereof.

In some aspects, the techniques described herein relate to a method, wherein the cellulosic material has a length-to-diameter ratio of at least about 10:1.

In some aspects, the techniques described herein relate to a method, wherein the size of the cellulosic material is at least about 0.01 mm to about 5 mm.

In some aspects, the techniques described herein relate to a method, wherein the cellulosic material is bamboo fiber and the length of the bamboo fiber is at least about 0.1 mm.

In some aspects, the techniques described herein relate to a method, wherein the thermoplastic polymer includes an olefin.

In some aspects, the techniques described herein relate to a method, wherein the olefin includes 1-olefins containing 2-10 carbons.

In some aspects, the techniques described herein relate to a method, wherein the olefin includes polyethylene, polypropylene, and/or a copolymer.

In some aspects, the techniques described herein relate to a method, wherein the thermoplastic polymer is a post-consumer and/or post-industrial, recycled polymer.

In some aspects, the techniques described herein relate to a method, wherein the admixture further includes a compatibilizing agent.

In some aspects, the techniques described herein relate to a method, wherein the compatibilizing agent includes one or more of: a titanium alcoholate; phosphoric acid ester, phosphorous acid ester, phosphonic acid ester, and silicic acid ester; metallic salts and esters of aliphatic, aromatic or cycloaliphatic acids; ethylene-acrylic acid copolymer (EAA), ethylene-methacrylic acid copolymer (EMAA), ethylene-ester of acrylic acid, ethylene ester or methacrylic acid, ethylene-vinyl acetate (EVA), styrene-maleic anhydride copolymer (SMA) or esters, acrylonitrile-butadiene-styrene copolymer (ABS), methacrylate-butadiene-styrene copolymer (MBS), styrene-acrylonitrile copolymer (SAN), or butadiene-acrylonitrile copolymer; and maleic anhydride or ester, acrylic or methacrylic acid or ester, vinyl acetate, acrylonitrile, and styrene.

In some aspects, the techniques described herein relate to a method, wherein the admixture further includes a plasticizer.

In some aspects, the techniques described herein relate to a method, wherein the plasticizer includes one or more of: phosphates, glycerides and esters of higher fatty acids and amides, glycol esters of coconut oil fatty acids, acetylated monogylceride, glycerine, dibutyl phthalate, diphenyl phthalate, castor oil, dicylclohexyl phthalate, butyl phthalyl, butyl glycolate, butyl ricinoleate, cresyldiphenyl phosphate, butyl stearate, benzyl phthalate, triethylcitrate, dibutylsebacate, sorbitol and triacetin or mixture thereof. D-sorbitol, triethylcitrate or mixtures thereof.

In some aspects, the techniques described herein relate to a method, wherein the admixture further includes a stabilizer.

In some aspects, the techniques described herein relate to a method, wherein the stabilizer includes one or more of phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and and mixtures thereof.

In some aspects, the techniques described herein relate to a method, wherein the average surface roughness (Ra) of the article is about 0.2 to about 25 micrometers.

In some aspects, the techniques described herein relate to a method, wherein the article absorbs water at about 0.2 to about 10 kg/m2s1/2 (ISO 15148).

In some aspects, the techniques described herein relate to a method, wherein the article is a paint tool.

In some aspects, the techniques described herein relate to a method, wherein the article is a paint brush, a paint brush roller core, a paint roller handle, a tray pan, a stir stick, a scraper, a paint pail, a bucket, a cut-in pail, an extension pole, a wire brush handle, a deck brush, a snap knife, a bucket opener, a can spout, a funnel, a paint pad handle, a sander handle, a trough, or a trim guide.

### DETAILED DESCRIPTION

While the disclosure has been described in connection with certain embodiments, it is to be understood that the disclosure is not to be limited to the disclosed embodiments but, on the contrary, is intended to cover various modifications and equivalent arrangements included within the scope of the appended claims.

Disclosed is a method of making an article comprising molding an admixture of a matrix resin and a reinforcing agent. Molding of the admixture may be accomplished any process sufficient for shaping the admixture. Exemplary processes include injection molding, blow molding, thermal forming, and extrusion. Injection molding of the article may be accomplished through a single point of injection. The admixture may have a melt flow ratio sufficient for manufacturing the desired articles having the desired properties as discussed in this application. The melt flow rate (MFR) of the admixture may be about 0.2 g/10 min or greater, about 0.5 g/10 min or greater, about 1 g/10 min or greater, about 5 g/10 min or greater, or about 10 g/10 min or greater. The melt flow rate (MFR) of the admixture may be about 75 g/10 min or less, about 60 g/10 min or less, about 50 g/10 min or less, about 40 g/10 min or less, or about 30 g/10 min or less. Melt flow rates are determined at 210° C. and a 2.16 kg load as per ISO 1133.

The admixture comprises a combination of a matrix resin and a reinforcing agent. In one embodiment, the matrix resin and reinforcing agent may be combined contemporaneously with molding the article, such as combination in an extruder. In another embodiment, the matrix resin and reinforcing agent combined prior to creation of the shaped article, such as by a separate process of extrusion into pellets.

The reinforcing agent may be a cellulosic material. “Cellulosic material” as used herein means any material containing the polysaccharide cellulose, including but not limited to the cell wall of plants, algae, and other oomycetes. The cellulosic material may be dried out before incorporation. Exemplary cellulosic materials include wood, bamboo, rice hull, hemp, flax, and straw. The cellulosic material may be bamboo.

The reinforcing agent may have any morphology which facilitates manufacture of the desired articles having the desired properties as discussed in this application. Exemplary morphologies include fibers, powders, and the like. The reinforcing agent may exhibit the morphology of a fiber. The reinforcing agents in fiber form may have any length to diameter ratio which facilitates manufacture of the desired articles having the desired properties as discussed in this application. The reinforcing agent fibers may have a length-to-diameter ratio of at least about 10:1, at least about 15:1, at least about 20:1, at least about 25:1, or at least about 30:1 to at most about 50:1. The reinforcing agent fibers may have any length that facilitates manufacture of the desired articles having the desired properties as discussed in this application. The reinforcing agent fibers may have a length of about 0.01 mm or greater, about 0.1 mm or greater, about 1 mm or greater, or about 2 mm or greater. Fibrous reinforcing agents may have a length of about 10 mm or less, about 5 mm or less, or about 3 mm or less. Powdered reinforcing agents may have a particle size of about 0.1 mm or greater or about 0.5 mm or greater.

The reinforcing agent may exhibit the morphology of a powder. The reinforcing agents in powder form may have a particle size and particle distribution which facilitates manufacture of the desired articles having the desired properties as discussed in this application. In defining a useful size, the particle size and size distribution is given by the median size (D50), D10, D90 and a maximum size limitation. The size is the equivalent spherical diameter by volume as measured by a laser light scattering method (Rayleigh or Mie with Mie scattering being preferred) using dispersions of the solids in liquids at low solids loading. D10 is the size where 10% of the particles have a smaller size, D50 (median) is the size where 50% of the particles have a smaller size and D90 is the size where 90% of the particles have a smaller size by volume. Generally, the reinforcing agent powder has an equivalent spherical diameter median (D50) particle size of 0.1 micrometer to 25 micrometers, D10 of 0.05 to 5 micrometers, D90 of 20 to 40 micrometers and essentially no particles greater than about 70 micrometers or even 50 micrometers and no particles smaller than about 0.01 micrometers. Desirably, the median is 5 to 10 micrometers, the D10 is 0.5 to 2 micrometers and the D90 is 20 to 30 micrometers. The reinforcing agent powder may have a particle size of about 2.0 mm or less or about 1.5 mm or less.

The reinforcing agent may be present in the admixture in amounts sufficient to allow the admixture to be moldable and to facilitate manufacture of the desired articles having the desired properties as discussed in this application. The reinforcing agent may be present in the admixture in an amount about 10 percent by weight of the admixture or greater, about 20 percent by weight of the admixture or greater, about 30 percent by weight of the admixture or greater, or about 40 percent by weight of the admixture or greater. The reinforcing agent may be present in the admixture in an amount about 70 percent by weight of the admixture or less, about 60 percent by weight of the admixture or less, about 50 percent by weight of the admixture or less, or about 40 percent by weight of the admixture or less.

The matrix resin may be any thermoplastic polymer capable of being molded and capable of manufacturing the desired articles having the desired properties as discussed in this application. Exemplary thermoplastic polymers include an olefin polymer, an olefin copolymer, a styrenic polymer, a styrenic copolymers, polyvinyl chloride, and polyurethane. The thermoplastic polymer may comprise linear or branched polymers and copolymers of 1-olefins. The thermoplastic polymer may comprise 1-olefins containing greater than 2 carbons, greater than 3 carbons, greater than 4 carbons, or greater than 5 carbons. The thermoplastic polymer may comprise 1-olefins containing less than 10 carbons, less than 9 carbons, less than 8 carbons, or less than 7 carbons. Exemplary 1-olefin polymers include polypropylene, polyethylene, and copolymers thereof.

The olefin polymer may comprise post-consumer or post-industrial recycled polymer. As used herein, post-consumer recycled polymer means a component part, intermediate, or final product that contains in whole, or in significant part, a waste material produced by the end consumer of a material stream. As used herein, post-industrial recycled polymer means a component part, intermediate, or final product that contains in whole, or in significant part, a waste material produced prior to the end consumer of a material stream and which may be reintroduced as manufacturing scrap back into the same or different manufacturing process.

The admixture may also be comprised of another additive, such as a plasticizer, a compatibilizer, and a stabilizer. Any suitable plasticizer capable of manufacturing the desired articles having the desired properties as discussed in this application may be used. Exemplary plasticizers include phosphates, glycerides and esters of higher fatty acids and amides, glycol esters of coconut oil fatty acids, acetylated monogylceride, glycerine, dibutyl phthalate, diphenyl phthalate, castor oil, dicylclohexyl phthalate, butyl phthalyl, butyl glycolate, butyl ricinoleate, cresyldiphenyl phosphate, butyl stearate, benzyl phthalate, triethylcitrate, dibutylsebacate, sorbitol and triacetin or mixture thereof. D-sorbitol, triethylcitrate or mixture thereof. The plasticizer may be present in the admixture in an amount of about sufficient to manufacture the desired articles having the desired properties as discussed in this application.

Inclusion of a compatibilizer may enhance the uniformity of mixture of the matrix resin and reinforcing agent. Any suitable compatibilizer capable of manufacturing the desired articles having the desired properties as discussed in this application may be used. Exemplary comptaibilizers include titanium alcoholate; phosphoric acid ester, phosphorous acid ester, phosphonic acid ester, and silicic acid ester; metallic salts and esters of aliphatic, aromatic or cycloaliphatic acids; ethylene-acrylic acid copolymer (EAA), ethylene-methacrylic acid copolymer (EMAA), ethylene-ester of acrylic acid, ethylene ester or methacrylic acid, ethylene-vinyl acetate (EVA), styrene-maleic anhydride copolymer (SMA) or esters, acrylonitrile-butadiene-styrene copolymer (ABS), methacrylate-butadiene-styrene copolymer (MBS), styrene-acrylonitrile copolymer (SAN), or butadiene-acrylonitrile copolymer; and maleic anhydride or ester, acrylic or methacrylic acid or ester, vinyl acetate, acrylonitrile, and styrene. The compatibilizer may be present in the admixture in an amount of about sufficient to manufacture the desired articles having the desired properties as discussed in this application, typically about 0.1 to 10 percent by weight with respect to the total weight of the admixture.

Any suitable stabilizer capable of manufacturing the desired articles having the desired properties as discussed in this application may be used. Exemplary stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. The stabilizer may be present in the admixture in an amount of about sufficient to manufacture the desired articles having the desired properties as discussed in this application.

Also disclosed is an article comprising a shaped article comprising an admixture of a matrix resin and a reinforcing agent. The shaped article may have a length-to-diameter ratio of at least about 5:1, at least 7.5:1, at least 10:1, at least 15:1 to at most about 50:1.

The shaped article may have a surface roughness and porosity or water absorption useful to make handles, for example, that allow for the absorption of sweat in a similar manner as unfinished wood paint brush handles. The shaped article may have an average surface roughness of about at least about 0.2 micrometers Ra (Arithmetic mean surface roughness) or greater, at least about 0.3 micrometers Ra or greater, at least about 0.4 micrometers Ra or greater. The shaped article may have an average surface roughness of about 8 micrometers Ra or less, about 7 micrometers Ra or less, about 6 micrometers Ra or less, about 5 micrometers Ra or less as determined by ISO 13565-3:2000. The shaped article may have an average water absorption of at least about 0.1 kg/m²s^{1/2} or greater, at least about 0.2 kg/m²s^{1/2} or greater, at least about 0.5 kg/m²s^{1/2} or greater, at least about 1 kg/m²s^{1/2} or greater, at least about 2 kg/m²s^{1/2} or greater, as determined using ISO 15148. The shaped article may have an average water absorption of at least about 25 kg/m²s^{1/2} or less, at least about 20 kg/m²s^{1/2} or less, at least about 15 kg/m²s^{1/2} or less, at least about 10 kg/m²s^{1/2} or less, at least about 5 kg/m²s^{1/2} or less, as determined using ISO 15148.

The shaped article may be a tool useful in painting. Exemplary tools useful in painting include a paint brush, a paint brush roller core, a paint roller handle, a tray pan, a stir stick, a scraper, a paint pail, a bucket, a cut-in pail, an extension pole, a wire brush handle, a deck brush, a snap knife, a bucket opener, a can spout, a funnel, a paint pad handle, a sander handle, a trough, and a trim guide.

### EMBODIMENTS

1. An article comprising:
a shaped article comprising an admixture of a cellulosic material and a thermoplastic polymer, wherein the cellulosic material is present in quantities ranging from about 10 to about 70 percent by weight with respect to the total weight of the admixture,
wherein the admixture has about a melt flow rate of about 1 to 30 g/10 min, (2.16 kg; 210° C.), and
wherein the shaped article has a length-to-diameter ratio of at least about 5:1.

2. The article of Embodiment 1, wherein the cellulosic material comprises one or more of bamboo, wood, rice hulls, hemp, straw, and flax.

3. The article according to Embodiment 1 or 2, wherein the cellulosic material is a fiber, powder, or mixtures thereof.

4. The article according to any one of Embodiments 1 to 3, wherein the length-to-diameter ratio of the cellulosic material is at least about 10:1.

5. The article according to any one of Embodiments 1 to 4, wherein the length of the cellulosic material is at least about 0.01 mm to about 5 mm.

6. The article according to Embodiment 5, wherein the cellulosic material is bamboo fiber and the length of the bamboo fiber is at least about 0.1 mm.

7. The article according to any one of Embodiments 1 to 6, wherein the thermoplastic polymer comprises an olefin.

8. The article according to Embodiment 7, wherein the olefin comprises 1-olefins containing 2-10 carbons.

9. The article according to Embodiment 8 or 9, wherein the olefin comprises polyethylene, polypropylene, and/or a copolymer.

10. The article according to any one of Embodiments 7 to 9, wherein the thermoplastic polymer is a post-consumer and/or post-industrial, recycled polymer.

11. The article according to any one of Embodiments 1 to 10, wherein the admixture further comprises a compatibilizing agent.

12. The article of Embodiment 11, wherein the compatibilizing agent comprises one or more of:
a titanium alcoholate;
phosphoric acid ester, phosphorous acid ester, phosphonic acid ester, and silicic acid ester;
metallic salts and esters of aliphatic, aromatic or cycloaliphatic acids;
ethylene-acrylic acid copolymer (EAA), ethylene-methacrylic acid copolymer (EMAA), ethylene-ester of acrylic acid, ethylene ester or methacrylic acid, ethylene-vinyl acetate (EVA), styrene-maleic anhydride copolymer (SMA) or esters, acrylonitrile-butadiene-styrene copolymer (ABS), methacrylate-butadiene-styrene copolymer (MBS), styrene-acrylonitrile copolymer (SAN), or butadiene-acrylonitrile copolymer; and
maleic anhydride or ester, acrylic or methacrylic acid or ester, vinyl acetate, acrylonitrile, and styrene.

13. The article according to any one of Embodiments 1 to 12, wherein the admixture further comprises a plasticizer.

14. The article according to Embodiment 13, wherein the plasticizer comprises one or more of:
phosphates, glycerides and esters of higher fatty acids and amides, glycol esters of coconut oil fatty acids, acetylated monogylceride, glycerine, dibutyl phthalate, diphenyl phthalate, castor oil, dicylclohexyl phthalate, butyl phthalyl, butyl glycolate, butyl ricinoleate, cresyldiphenyl phosphate, butyl stearate, benzyl phthalate, triethylcitrate, dibutylsebacate, sorbitol and triacetin or mixture thereof. D-sorbitol, triethylcitrate or mixtures thereof.

15. The article according to any one of Embodiments 1 to 14, wherein the admixture further comprises a stabilizer.

16. The article according to Embodiment 15, wherein the stabilizer comprises one or more of phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and and mixtures thereof.

17. The article according to any one of Embodiments 1 to 16, wherein the average surface roughness (Ra) of the shaped article is about 0.2 to about 25 micrometers.

18. The article according to any one of Embodiments 1 to 17, wherein the shaped article absorbs water at a rate of about 0.2 to about 10 kg/m²s^{1/2}.

19. The article according to any one of Embodiments 1 to 18, wherein the shaped article is a paint tool.

20. The article of Embodiment 19, wherein the shaped article is a paint brush, a paint brush roller core, a paint roller handle, a tray pan, a stir stick, a scraper, a paint pail, a bucket, a cut-in pail, an extension pole, a wire brush handle, a deck brush, a snap knife, a bucket opener, a can spout, a funnel, a paint pad handle, a sander handle, a trough, or a trim guide.

21. A method of making an article comprising:
injecting an admixture of a cellulosic material and a thermoplastic polymer into a mold cavity with single point of injection,
wherein the cellulosic material is present in quantities ranging from about 10 to about 70 percent by weight with respect to the total weight of the admixture,
wherein the admixture has about a melt flow rate of about 1 to 30 g/10 min, (2.16 kg; 210° C.), and
wherein the article has a length-to-diameter ratio of at least about 5:1.

22. The method of Embodiment 21, wherein the cellulosic material comprises one more of bamboo, wood, rice hulls, hemp, straw, and flax.

23. The method according to Embodiment 21 or 22, wherein the cellulosic material is a fiber, powder, or mixtures thereof.

24. The method according to any one of Embodiments 21 to 23, wherein the cellulosic material has a length-to-diameter ratio of at least about 10:1.

25. The method according to any one of Embodiments 21 to 24, wherein the size of the cellulosic material is at least about 0.01 mm to about 5 mm.

26. The method according to Embodiment 25, wherein the cellulosic material is bamboo fiber and the length of the bamboo fiber is at least about 0.1 mm.

27. The method according to any one of Embodiments 21 to 26, wherein the thermoplastic polymer comprises an olefin.

28. The method according to Embodiment 27, wherein the olefin comprises 1-olefins containing 2-10 carbons.

29. The method according to Embodiment 27 or 28, wherein the olefin comprises polyethylene, polypropylene, and/or a copolymer.

30. The method according to any one of Embodiments 27 to 29, wherein the thermoplastic polymer is a post-consumer and/or post-industrial, recycled polymer.

31. The method according to any one of Embodiments 21 to 30, wherein the admixture further comprises a compatibilizing agent.

32. The method of Embodiment 31, wherein the compatibilizing agent comprises one or more of:
a titanium alcoholate;
phosphoric acid ester, phosphorous acid ester, phosphonic acid ester, and silicic acid ester;
metallic salts and esters of aliphatic, aromatic or cycloaliphatic acids;
ethylene-acrylic acid copolymer (EAA), ethylene-methacrylic acid copolymer (EMAA), ethylene-ester of acrylic acid, ethylene ester or methacrylic acid, ethylene-vinyl acetate (EVA), styrene-maleic anhydride copolymer (SMA) or esters, acrylonitrile-butadiene-styrene copolymer (ABS), methacrylate-butadiene-styrene copolymer (MBS), styrene-acrylonitrile copolymer (SAN), or butadiene-acrylonitrile copolymer; and
maleic anhydride or ester, acrylic or methacrylic acid or ester, vinyl acetate, acrylonitrile, and styrene.

33. The method according to any one of Embodiments 21 to 32, wherein the admixture further comprises a plasticizer.

34. The method according to Embodiment 33, wherein the plasticizer comprises one or more of:
phosphates, glycerides and esters of higher fatty acids and amides, glycol esters of coconut oil fatty acids, acetylated monogylceride, glycerine, dibutyl phthalate, diphenyl phthalate, castor oil, dicylclohexyl phthalate, butyl phthalyl, butyl glycolate, butyl ricinoleate, cresyldiphenyl phosphate, butyl stearate, benzyl phthalate, triethylcitrate, dibutylsebacate, sorbitol and triacetin or mixture thereof. D-sorbitol, triethylcitrate or mixtures thereof.

35. The method according to any one of Embodiments 21 to 34, wherein the admixture further comprises a stabilizer.

36. The method according to Embodiment 35, wherein the stabilizer comprises one or more of phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and and mixtures thereof.

37. The method according to any one of Embodiments 21 to 36, wherein the average surface roughness (Ra) of the article is about 0.2 to about 25 micrometers.

38. The method according to any one of Embodiments 21 to 37, wherein the article absorbs water at about 0.2 to about 10 kg/m²s^{1/2}.

39. The method according to any one of Embodiments 21 to 38, wherein the article is a paint tool.

40. The method of Embodiment 39, wherein the article is a paint brush, a paint brush roller core, a paint roller handle, a tray pan, a stir stick, a scraper, a paint pail, a bucket, a cut-in pail, an extension pole, a wire brush handle, a deck brush, a snap knife, a bucket opener, a can spout, a funnel, a paint pad handle, a sander handle, a trough, or a trim guide.

What is claimed is:

1. An article comprising:
a shaped article comprising an admixture of a cellulosic material and a thermoplastic polymer,
wherein the cellulosic material is present in quantities ranging from about 10 to about 70 percent by weight with respect to the total weight of the admixture,
wherein the admixture has about a melt flow rate of about 1 to 30 g/10 min, (2.16 kg; 210° C.), and
wherein the shaped article has a length-to-diameter ratio of at least about 5:1.

2. The article of claim 1, wherein the cellulosic material comprises one or more of bamboo, wood, rice hulls, hemp, straw, and flax.

3. The article according to claim 1, wherein the cellulosic material is a fiber, powder, or mixtures thereof.

4. The article according to claim 1, wherein the length-to-diameter ratio of the cellulosic material is at least about 10:1.

5. The article according to claim 1, wherein the length of the cellulosic material is at least about 0.01 mm to about 5 mm.

6. The article according to claim 5, wherein the cellulosic material is bamboo fiber and the length of the bamboo fiber is at least about 0.1 mm.

7. The article according to claims 1, wherein the thermoplastic polymer comprises an olefin.

8. The article according to claim 7, wherein the olefin comprises polyethylene, polypropylene, and/or a copolymer.

9. The article according to claim 7, wherein the thermoplastic polymer is a post-consumer and/or post-industrial, recycled polymer.

10. The article according to claim 1, wherein the admixture further comprises a compatibilizing agent.

11. The article of claim 10, wherein the compatibilizing agent comprises one or more of:
a titanium alcoholate;
phosphoric acid ester, phosphorous acid ester, phosphonic acid ester, and silicic acid ester;
metallic salts and esters of aliphatic, aromatic or cycloaliphatic acids;
ethylene-acrylic acid copolymer (EAA), ethylene-methacrylic acid copolymer (EMAA), ethylene-ester of acrylic acid, ethylene ester or methacrylic acid, ethylene-vinyl acetate (EVA), styrene-maleic anhydride copolymer (SMA) or esters, acrylonitrile-butadiene-styrene copolymer (ABS), methacrylate-butadiene-styrene copolymer (MBS), styrene-acrylonitrile copolymer (SAN), or butadiene-acrylonitrile copolymer; and
maleic anhydride or ester, acrylic or methacrylic acid or ester, vinyl acetate, acrylonitrile, and styrene.

12. The article according to claim 1, wherein the admixture further comprises a plasticizer.

13. The article according to claim 12, wherein the plasticizer comprises one or more of:
phosphates, glycerides and esters of higher fatty acids and amides, glycol esters of coconut oil fatty acids, acetylated monogylceride, glycerine, dibutyl phthalate, diphenyl phthalate, castor oil, dicylclohexyl phthalate, butyl phthalyl, butyl glycolate, butyl ricinoleate, cresyldiphenyl phosphate, butyl stearate, benzyl phthalate, triethylcitrate, dibutylsebacate, sorbitol and triacetin or mixture thereof. D-sorbitol, triethylcitrate or mixtures thereof.

14. The article according to claim 1, wherein the admixture further comprises a stabilizer.

15. The article according to claim 14, wherein the stabilizer comprises one or more of phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and and mixtures thereof.

16. The article according to claim 15, wherein the average surface roughness (Ra) of the shaped article is about 0.2 to about 25 micrometers.

17. The article according to claim 1, wherein the shaped article absorbs water at a rate of about 0.2 to about 10 kg/m²s^{1/2}.

18. The article according to claim 1, wherein the shaped article is a paint tool.

19. The article of claim 18, wherein the shaped article is a paint brush, a paint brush roller core, a paint roller handle, a tray pan, a stir stick, a scraper, a paint pail, a bucket, a cut-in pail, an extension pole, a wire brush handle, a deck brush, a snap knife, a bucket opener, a can spout, a funnel, a paint pad handle, a sander handle, a trough, or a trim guide.

20. A method of making an article according to claim 1 comprising:
injecting an admixture of a cellulosic material and a thermoplastic polymer into a mold cavity with single point of injection,
wherein the cellulosic material is present in quantities ranging from about 10 to about 70 percent by weight with respect to the total weight of the admixture,
wherein the admixture has about a melt flow rate of about 1 to 30 g/10 min, (2.16 kg; 210° C.), and
wherein the article has a length-to-diameter ratio of at least about 5:1.
